(19) United States
(12) Patent Application Publication
(10) Pub. No.: US 2025/0031924 A1
(43) Pub. Date: Jan. 30, 2025

(54) JOBSITE STORAGE SYSTEM

(71) Applicant: MILWAUKEE ELECTRIC TOOL CORPORATION, Brookfield, WI (US)

(72) Inventors: Manas M. Mahaddalkar, Milwaukee, WI (US); Timothy J. Campbell, Brookfield, WI (US); Richard M. Schieber, Milwaukee, WI (US); Bradford A. Gill, Brookfield, WI (US); Benjamin Teske, Milwaukee, WI (US); Patrick P. Stockwell, Wauwatosa, WI (US); Alexander J. Goodman, Milwaukee, WI (US); Adam M. Schroeder, Waterford, WI (US); Austin F. de Veer, Lake Orion, MI (US); Danielle Newman, Menomonee Falls, WI (US); Jessica Osgoodby, Chicago, IL (US)

(21) Appl. No.: 18/782,999

(22) Filed: Jul. 24, 2024

Related U.S. Application Data
(60) Provisional application No. 63/515,254, filed on Jul. 24, 2023.

(51) Int. Cl. A47L 9/00; B25H 3/02; B62B 3/00; B62B 5/06

(52) U.S. Cl. CPC A47L 9/009; B25H 3/023; B62B 3/005; B62B 5/06

(57) ABSTRACT

A jobsite storage system may include a vacuum device having a suction source configured to generate a suction airflow and a tank configured to receive debris via the suction airflow. A jobsite storage system may include a storage cart having: a base configured to support the vacuum device thereon, the base movable on a ground surface via a plurality of wheels, a handle extending upward from the base to a grip such that the storage cart is movable via an input of an operator to the grip, a first securing interface located on the base and configured to removably engage the vacuum device to secure the vacuum device to the base; a second securing interface located on the handle and configured to removably engage an accessory, and a third securing interface located on the vacuum device and configured to removably engage the accessory.

### CROSS-REFERENCE TO RELATED APPLICATIONS

This application claims priority to co-pending U.S. Provisional Patent Application No. 63/515,254 filed on Jul. 24, 2023, the entire contents of which is incorporated herein by reference.

### FIELD OF THE INVENTION

The present invention relates to jobsite storage systems, and more particularly to storage carts having accessory storage arrangements.

### BACKGROUND OF THE INVENTION

On job sites, operators use vacuum cleaners to clean up dust and debris. Some vacuum cleaners have a base with wheels, while other vacuum cleaners omit wheels, having a base that rests upon a horizontal surface. A cart may be utilized on the jobsite to transport a vacuum cleaner that omits wheels. Other carts that omit a vacuum device may be used for other purposes, such as cleaning carts that support, for example, waste receptacles.

### SUMMARY OF THE INVENTION

In some aspects, the techniques described herein relate to a jobsite storage system including: a vacuum device having a suction source configured to generate a suction airflow and a tank configured to receive debris via the suction airflow; a storage cart having: a base configured to support the vacuum device thereon, the base movable on a ground surface via a plurality of wheels; a handle extending upward from the base to a grip such that the storage cart is movable via an input of an operator to the grip; a first securing interface located on the base and configured to removably engage the vacuum device to secure the vacuum device to the base; a second securing interface located on the handle and configured to removably engage an accessory; and a third securing interface located on the vacuum device and configured to removably engage the accessory.

In some aspects, the techniques described herein relate to a jobsite storage system including: a base having a plurality of wheels such that the base is movable on a ground surface, the base extending substantially parallel to the ground surface; a handle extending from the base, transverse to the base, and terminating at a grip such that the jobsite storage system is movable via an input of an operator to the grip; a panel coupled to and extending along the handle from a lower end adjacent the base to an upper end located between the lower end of the panel and the grip, the panel including an array of spaced apart securing interfaces, a jobsite accessory secured to any securing interface of the array of spaced apart securing interfaces.

In some aspects, the techniques described herein relate to a jobsite storage system including: a vacuum device having a suction source configured to generate a suction airflow and a tank configured to receive debris via the suction airflow; a storage cart having: a base configured to support the vacuum device thereon, the base movable on a ground surface via a plurality of wheels; a handle extending upward from the base to a grip such that the storage cart is movable via an input of an operator to the grip; a first securing interface located on the base and configured to engage the vacuum device to secure the vacuum device to the base; and a first panel mounted substantially vertically to the handle, the first panel having a plurality of second securing interfaces configured to engage an accessory; and a second panel mounted substantially horizontally above the vacuum device such that the vacuum device is located between the base and the second panel, the second panel having a plurality of third securing interfaces configured to engage the accessory.

Other features and aspects of the invention will become apparent by consideration of the following detailed description and accompanying drawings.

### BRIEF DESCRIPTION OF THE DRAWINGS

FIG. 1 is a perspective view of a jobsite storage system having a vacuum device and a storage cart.

FIG. 2 is a further perspective view of the jobsite storage system of FIG. 1.

FIG. 3 is a side view of the jobsite storage system of FIG. 1.

FIG. 4 is a front view of the jobsite storage system of FIG. 1.

FIG. 5 is a rear view of the jobsite storage system of FIG. 1.

FIG. 6 is a perspective view of a tank of the vacuum device of FIG. 1.

FIG. 7 is a further perspective view of the tank of the vacuum device of FIG. 1.

FIG. 8A is a perspective view of a jobsite accessory, a basket.

FIG. 8B is a perspective view of a further jobsite accessory, a hook.

FIG. 8C is a perspective view of a further jobsite accessory, a paper towel holder.

FIG. 8D is a perspective view of a further jobsite accessory, a further basket.

FIG. 8E is a perspective view of a further jobsite accessory, a further basket.

FIG. 8F is a perspective view of a further jobsite accessory, a broom holder.

FIG. 8G is a rear perspective view of the jobsite accessory of FIG. 8A.

FIG. 8H is a cross-sectional view of the jobsite accessory of FIG. 8A received within adjacent openings of the jobsite storage system of FIG. 1.

FIG. 9 is a perspective view of a further jobsite storage system having a vacuum device and a storage cart.

FIG. 10 is a perspective view of a jobsite storage system according to another embodiment.

FIG. 11 is a further perspective view of the jobsite storage system of FIG. 10.

FIG. 12 is a side view of the jobsite storage system of FIG. 10.

FIG. 13 is a rear view of the jobsite storage system of FIG. 10.

FIG. 14 is a rear perspective view of the jobsite storage system of FIG. 10 having a plurality of jobsite accessories mounted thereon.

FIG. 15 is a rear perspective view of the jobsite storage system of claim 10 having jobsite accessories mounted thereon.

FIG. 16 is a further rear perspective view of the jobsite storage system of claim 10.

FIG. 17 is a perspective view of a jobsite storage system according to another embodiment.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

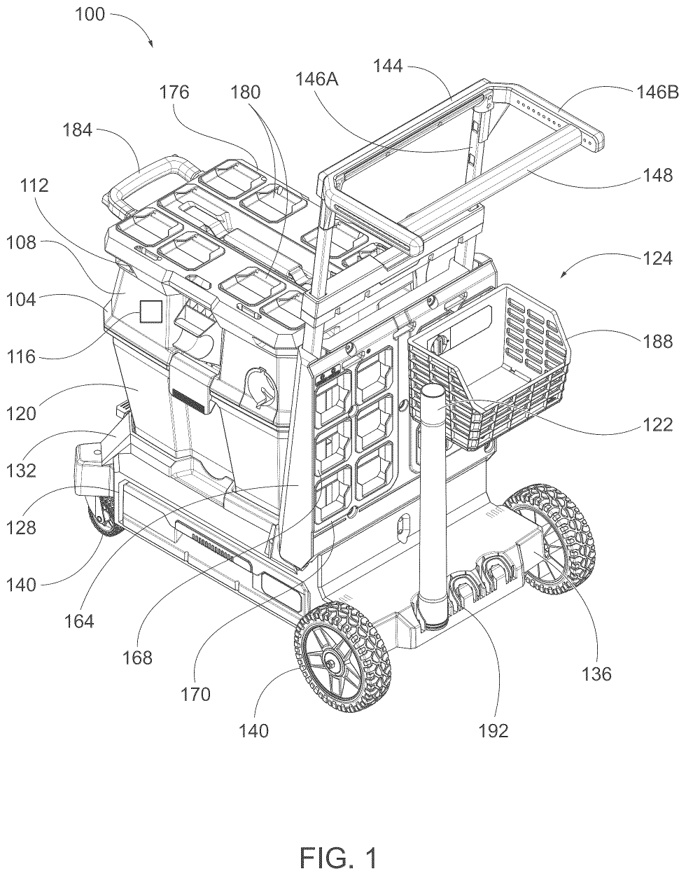

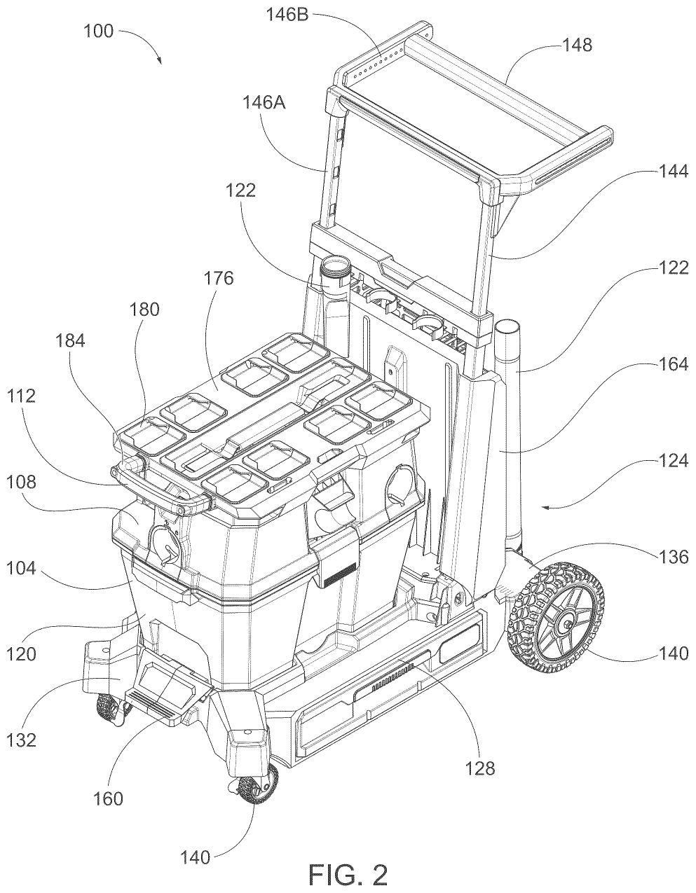

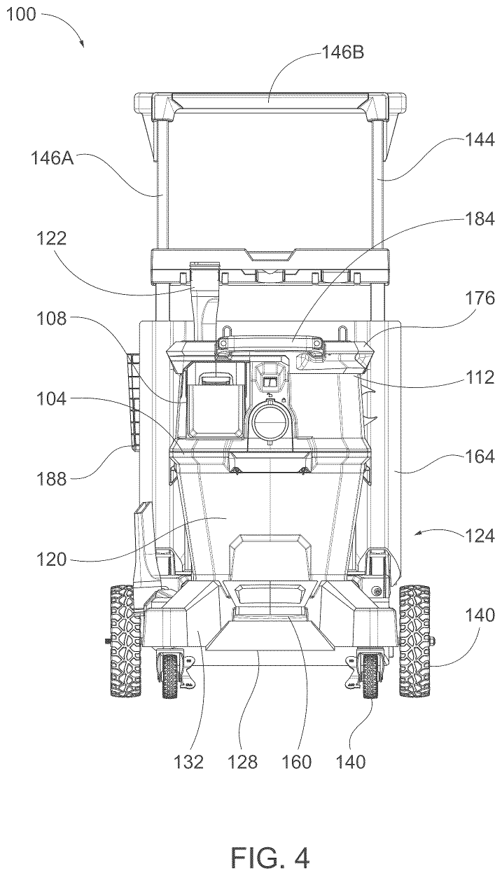

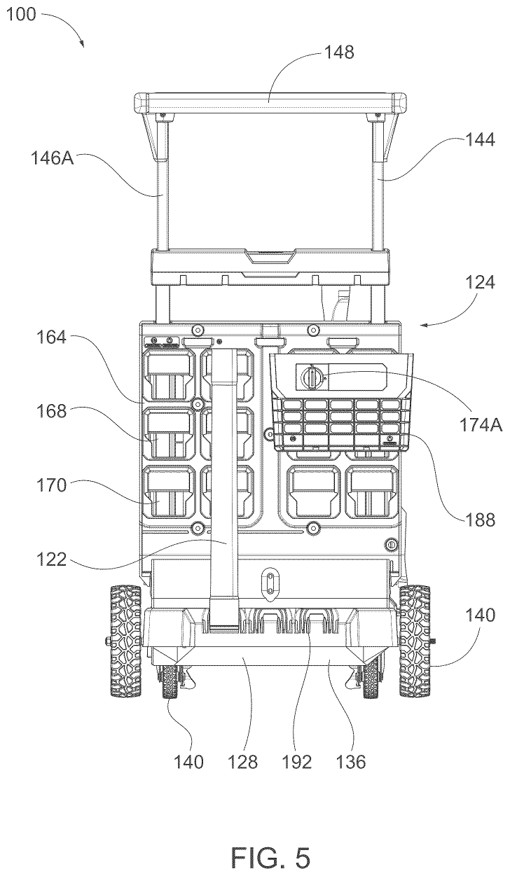

As shown in FIGS. 1-5, a jobsite storage system 100 includes a vacuum device 104 and a storage cart 124 upon which the vacuum device 104 is secured. The vacuum device 104, when not coupled to the storage cart 124 is a wheel less vacuum device 104 such that the vacuum device 104 has an underside 106 that sits flat upon a horizontal ground surface. The vacuum device 104 includes a head 108 (i.e., a power head, a head unit) positioned atop a tank 120 (i.e., dust and debris container) and selectively removable from the tank 120 to permit a user to empty the debris from within the tank 120. The head 108 defines an upper side 112 of the vacuum device 104 opposite the underside 106. A suction source 116 is located within the head 108 and generates an airflow to draw dust and debris into the tank 120. In some embodiments, the suction source 116 includes a motor-driven fan. One or more hoses may be attached to the vacuum device 104 at the head 108 or the tank 120 and various vacuum attachments 122 (e.g., hose extender, crevice tool, brush tool, etc.) may be coupled to the hose.

The storage cart 124 includes a base 128, a plurality of wheels 140 that support the base 128 and a handle 144 extending from the base 128. The base 128 includes a generally planar upper surface upon which the vacuum device 104 rests when mounted to the storage cart 124. The base 128 extends from a front end 132 to a rear end 136, opposite the front end 132, with the handle 144 coupled to the base 128 nearer to the rear end 136 than the front end 132. In some embodiments, the handle 144 is coupled to the base 128 at a location intermediate between the front and rear ends 132, 136. The wheels 140 include two front wheels (e.g., rotatable casters) and two rear wheels (e.g., fixed axis wheels). In the embodiment shown, the rear wheels are larger than the front wheels.

The handle 144 extends upward from the base 128. In some embodiments, the handle 144 extends upward and rearward from the base 128 such that the top of the handle 144 is located rearward relative to the bottom of the handle 144. A grip 148 is located at the top end of the handle 144, the grip 148 being graspable by a user such that the jobsite storage system 100 is movable via an input to the grip 148. The handle 144 illustrated in FIGS. 1-5 includes a first portion 146A that extends generally upward (e.g., at an angle of 70 to 90 degrees relative to the generally planar upper surface of the base 128. A second portion 146B of the handle 144 extends rearward from the top end of the first portion 146A. As shown, the second portion 146B is generally horizontal, extending substantially parallel to the upper surface of the base 128, with the grip 148 formed on a distal end of the second portion 146B of the handle 144.

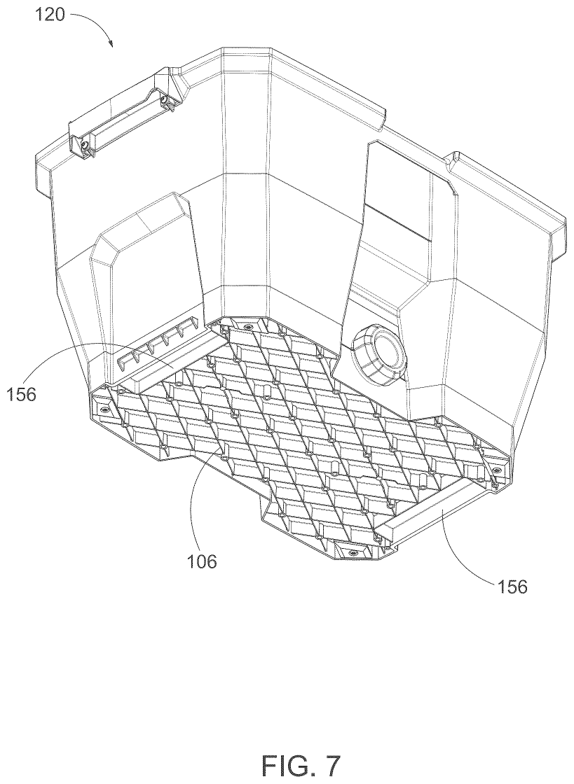

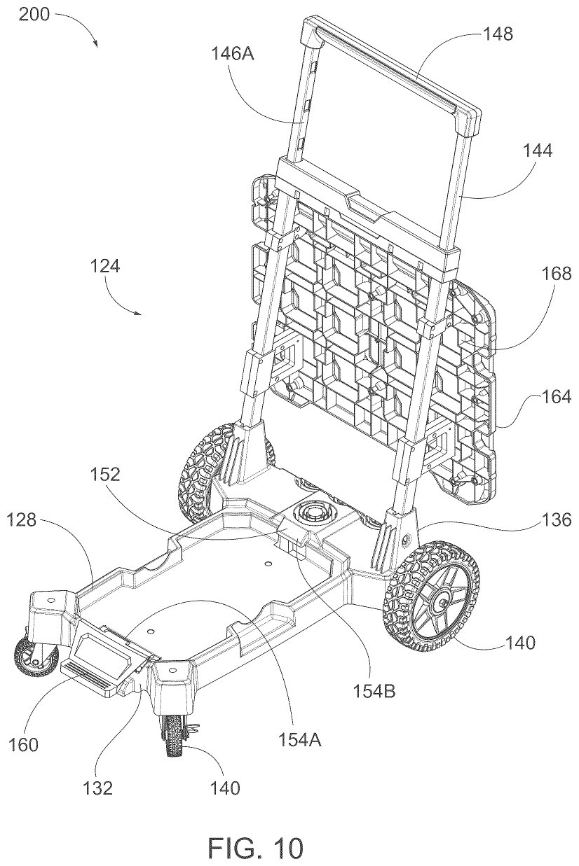

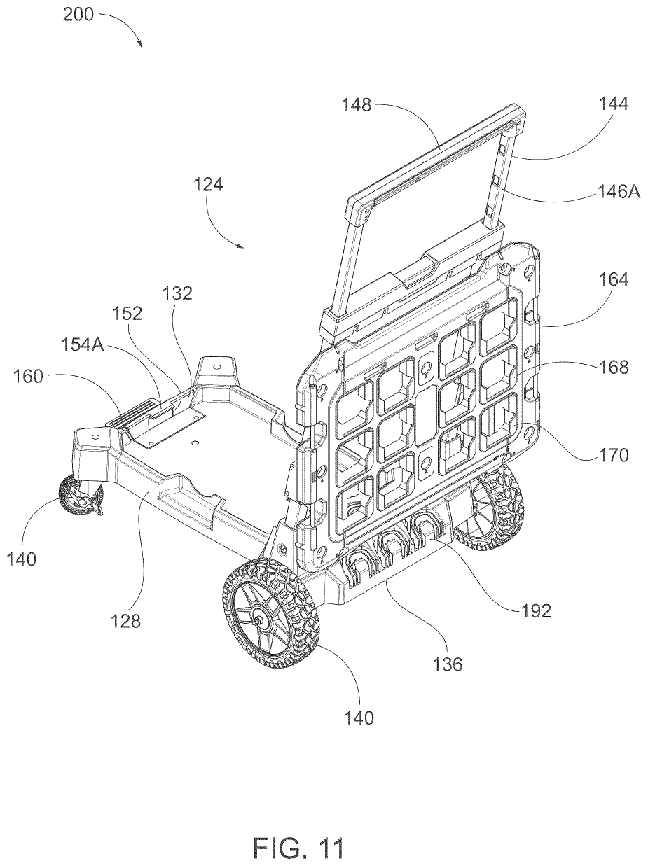

The vacuum device 104 is removably secured to the base 128 of the storage cart 124 via a first securing interface 152 located on the base 128. The first securing interface 152 is integrally formed within the base 128 and is formed via a combination of a movable clip 154A (FIG. 11) and a stationary clip 154B (FIG. 10). The two clips 154A, 154B of the first securing interface engage a mating interface 156 (e.g., slots; FIG. 7) located on or adjacent to the underside 106 of the vacuum device 104. When in an engaged position, the two clips 154A, 154B extend into the slots 156. The base 128 includes a release 160, as shown formed as a foot pedal, that is engageable by a user to move the movable clip 154A from an engaged position to a disengaged position such that the vacuum device 104 is removable from the storage cart 124. The movable clip 154A is biased to the engaged position and moved away from the engaged position by the release 160. The release is formed at the front end 132 of the base 128.

To secure the vacuum device 104 to the storage cart 124, a user engages a slot 156 of the vacuum device 104 with the stationary clip 154B of the base 128. The vacuum device 104 is then lowered into engagement with the movable clip 154A, moving the movable clip 154A from out of the engaged position, returning to the engaged position (via the bias of the movable clip 154A) once the movable clip 154A is located within the corresponding slot 156. To remove the vacuum device 104 from the base 128 of the storage cart 124, the user pushes down on the release 160, moving the movable clip 154A from the engaged position to the disengaged position such that the vacuum device 104 can be lifted away from the base 128 at the front clip 154A, effectively pivoting about the rear clip 154B. Once disengaged from the front clip 154A, the rear clip 154B is slid out of the corresponding slot 146B to fully separate the vacuum device 104 from the storage cart 124.

With continued reference to FIGS. 1-5, a first panel 164 is coupled to the handle 144 and extends substantially vertically (relative to a horizontal ground surface upon which the storage cart 124 rests) along the length of the handle 144. The first panel 164 may be fixedly mounted to the handle 144 or may be releasably coupled to the handle 144 through quick-release fasteners. As shown, the first portion 146A of the handle 144 includes two spaced apart posts and the first panel 164 extends between and connects the two posts. The first panel extends a majority (i.e., greater than 50%) of the height of the handle 144. In the embodiment shown, the panel 164 extends upwards from adjacent the base 128 and terminates prior to the height of the grip 148. In some embodiments, the length of the handle 144 (i.e., the height of the grip 148 above the base 128) is adjustable, with the adjustability (i.e., nesting of posts) located above the first panel 164.

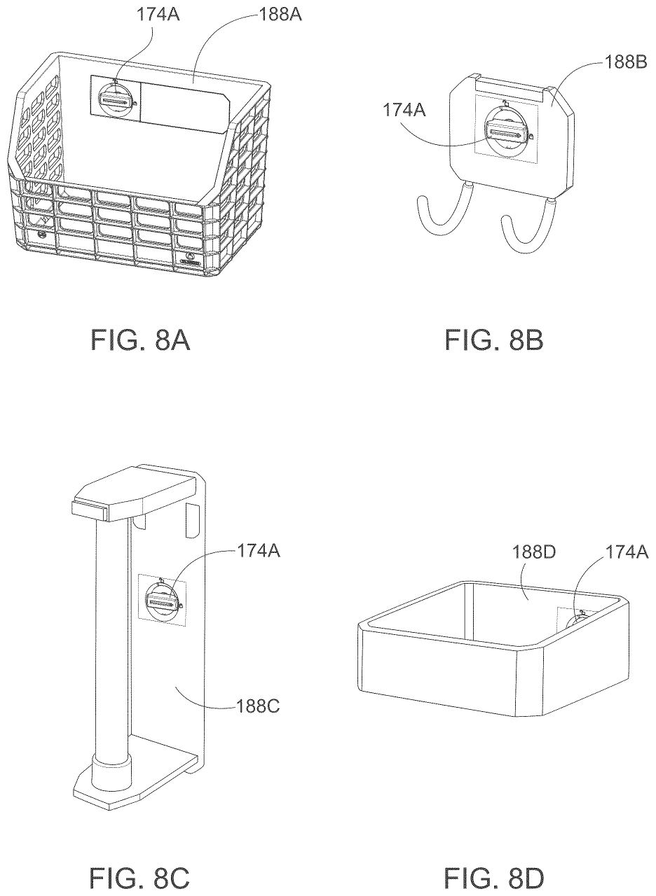

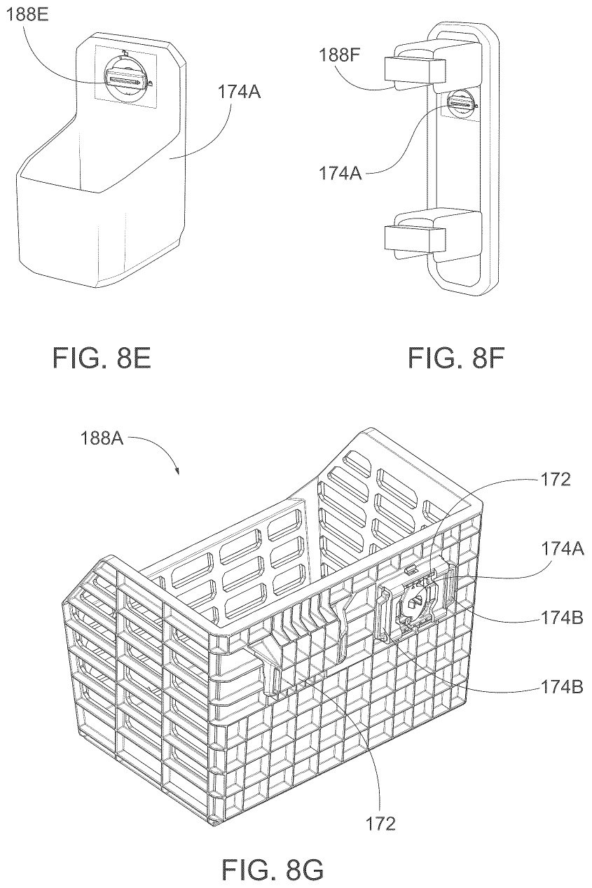

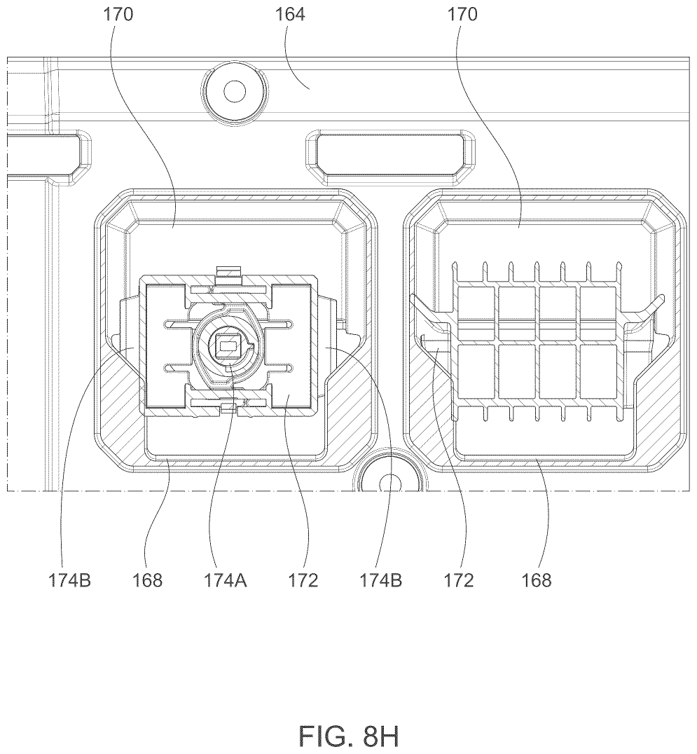

The first panel 164 includes an array of second securing interfaces 168 configured to receive various jobsite accessories 188, which are described in greater detail with respect to FIGS. 8A-8F. The second securing interfaces 168 are arranged in a rectangular array of multiple rows and multiple columns. As shown, the array includes three columns and four rows for twelve total second securing interfaces 168. In other embodiments, more or fewer second securing interfaces 168 may be located on the first panel 164. Further, in other embodiments, the array may be non-rectangular (i.e., offset rows or columns or spaced about other non-second securing interfaces).

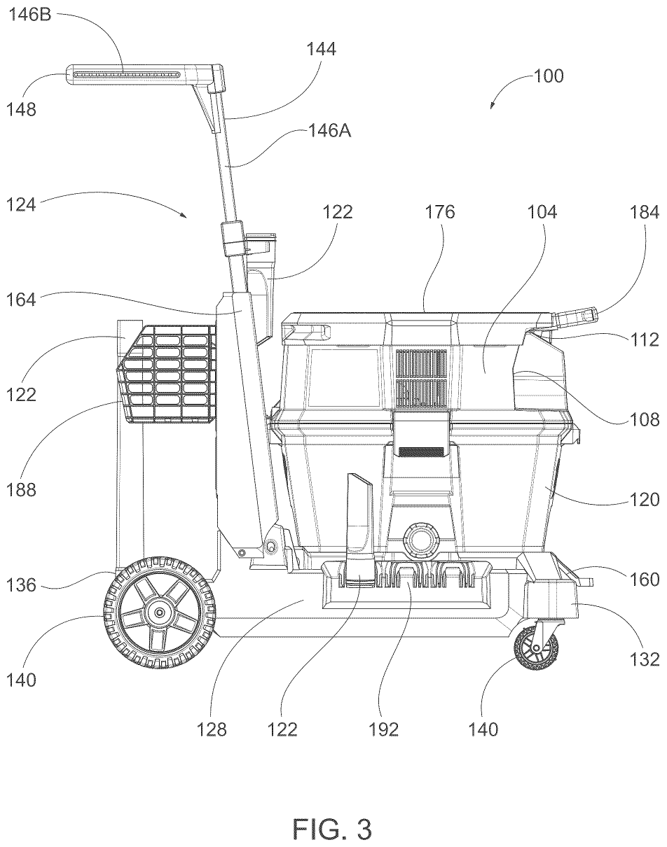

As the first portion 146A of the handle 144 has a horizontal component (i.e., does not extend solely vertically), in order for the first panel 164 to extend vertically, the bottom of the panel 164 is spaced apart from the handle 144 by a greater distance than the top of the first panel 164. As shown most clearly in FIG. 3, the thickness of the first panel 164, at least in regions of the handle 144, is thicker (or extends a greater distance) to couple to the handle 144.

Each of the second securing interfaces 168 includes a keyhole-shaped aperture 170 or recess with an upper portion of the aperture 170 having a greater width than a bottom portion of the aperture. As shown in FIGS. 8G-8H, each jobsite accessory 188 includes an interface 172 configured to extend through the larger upper portion of the aperture 170 and drop down into the lower portion. As shown, the interface 172 is a protrusion having a width less than the upper portion of the aperture 170 but less than the lower portion of the aperture 170 so as to be retained within the aperture 170. Further, each jobsite accessory 188 includes a locking element 174 configured to transition between a locked position in which the jobsite accessory 188 is secured within the aperture 170 and an unlocked position in which the jobsite accessory 188 is removable from the aperture 170. As shown, the locking element 174A is a rotatable switch. When the switch 174A is rotated from an unlocked position to a locked position, wings 174B on the switch 174A extend outward such that the width of the interface 172 is greater than either portion of the keyhole-shaped aperture 170 to prevent removal of the interface 172 from the aperture 170. In some embodiments, movement of the wings 174B outward also moves the wings 174B into physical (e.g., frictional) engagement with the panel 164.

Some jobsite accessories 188 are sized to engage only a single one of the second securing interfaces 168. However, other accessories 188, such as the basket 188 shown in FIGS. 8G and 8H has a width great enough to engage multiple adjacent second securing interfaces 168. In the embodiment shown, even though the accessory 188 engages multiple interfaces 168, the accessory 188 only includes a single locking element 174A. In other embodiments, each interface 172 that mates with a corresponding aperture 170 includes a corresponding locking element 174A.

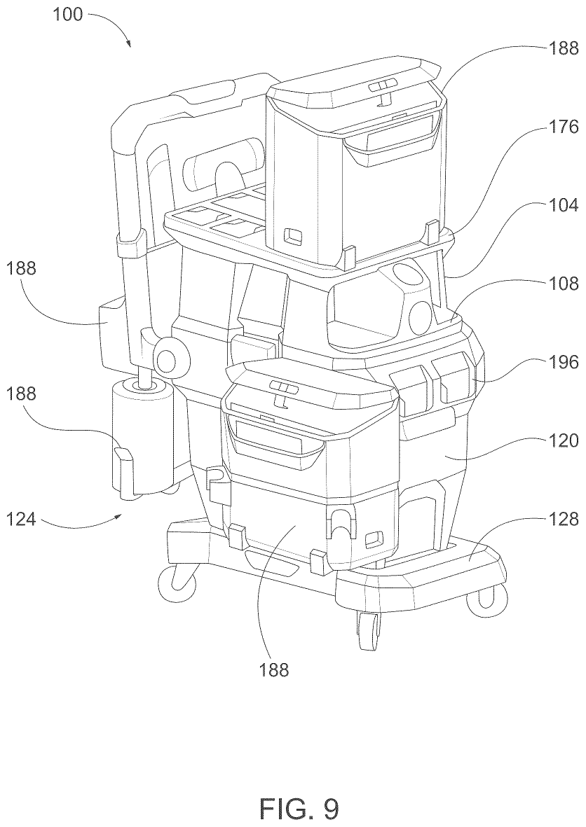

With reference to FIGS. 1-5, a second panel 176 is located on and above the vacuum device 104. The second panel 176 may be integrally formed with the head 108 or may be detachably attached to the head 108 through a quick-release coupling (not shown). The second panel 176 is similar in function and shape to the first panel 164, though, as shown, may have an alternative arrangement of securing interfaces 180. The securing interfaces 180 of the second panel 176, considered third securing interfaces herein for clarity, are identical in shape and function to the second securing interfaces 168 such that an accessory 188 that is couplable to the second securing interfaces 168 is also couplable to the third securing interfaces 180. The second panel 176 is oriented perpendicular to the first panel 164, extending substantially horizontally and parallel to the base 128 of the cart 124. As such, accessories 188 mounted to the first panel 164 can be used in an alternative manner when coupled to the second panel 176 based on the rotated orientation. As shown, the second panel 176 is mounted atop the upper side 112 of the vacuum device. In some embodiments, such as is shown in FIG. 9, further securing interfaces 196 may be incorporated directly into the head 108 of the vacuum device 104. A second handle 184 is provided at a forward end of the second panel 176 such that the storage cart 124 can be pushed (or pulled) from the end opposite to the handle 144.

By implementing a large array of mounting locations for different jobsite accessories 188 in multiple different orientations, the jobsite storage system 100 is equipped for modularity to accommodate multiple different applications. The jobsite accessories desirable for a carpenter may differ from those desirable by a custodian, and the implementation of a clean drawing board, provides the ability to customize as desired.

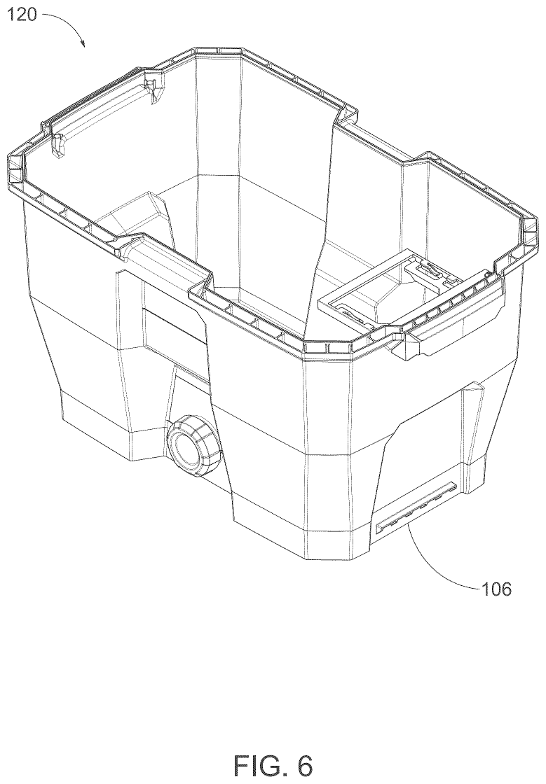

FIGS. 8A-8F illustrate various jobsite accessories 188, each of which is labeled within the aforementioned figures with a corresponding alphabetical suffix. FIG. 8A illustrates a basket 188A, as discussed above with respect to FIGS. 1-7 and FIGS. 8G-8H. The basket 188A includes an upper opening and a pattern of rectangular openings along the other sides. In some embodiments, cleaning materials (e.g., cleaning sprays, rags) may be stored within the basket 188A. FIG. 8B illustrates a hook 188B including first and second hook elements from which different devices (e.g., spray bottles, plastic bags, etc.) can be hung on the storage cart 124. FIG. 8C illustrates a paper towel dispenser 188C having a rod configured to support a roll of paper towel. FIG. 8D illustrates a further basket 188D, with lower, but more solid sidewalls than the basket 188A (FIG. 8A). FIG. 8E illustrates a narrower basket 188E (e.g., a water bottle holder) and FIG. 8F illustrates a broom holder 188F configured to hold the pole of a broom or other implement having a pole (e.g., a rake, a shovel, etc.).

In addition to the various securing interfaces 152, 168, 180, the jobsite storage system includes various vacuum accessory mounts 192 for supporting accessories specific to the vacuum device 104, such as, hoses, hose extensions, crevice tools, and brushed hose tools. As shown in FIG. 3, in some embodiments, the accessory mounts 192 are located on the base 128. In other embodiments, the accessory mounts 192 are located on the handle 144.

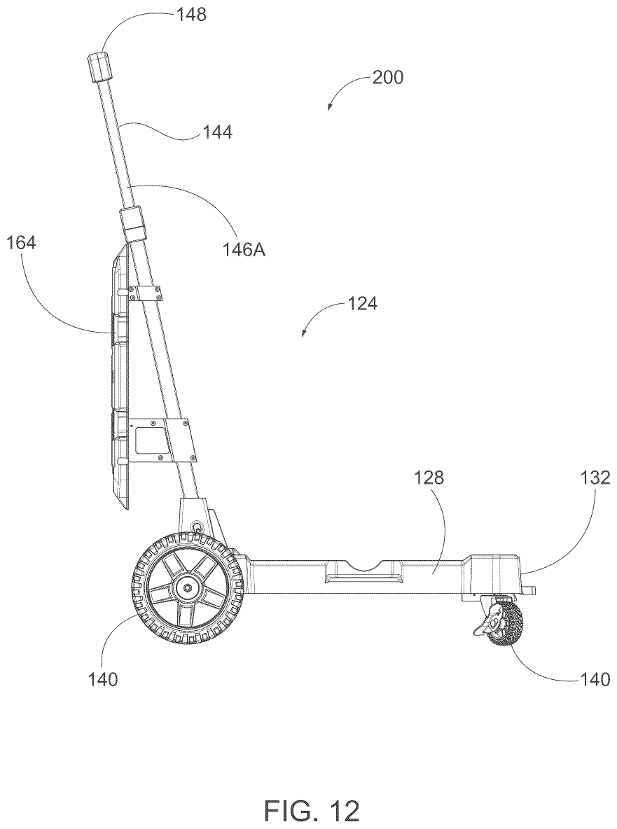

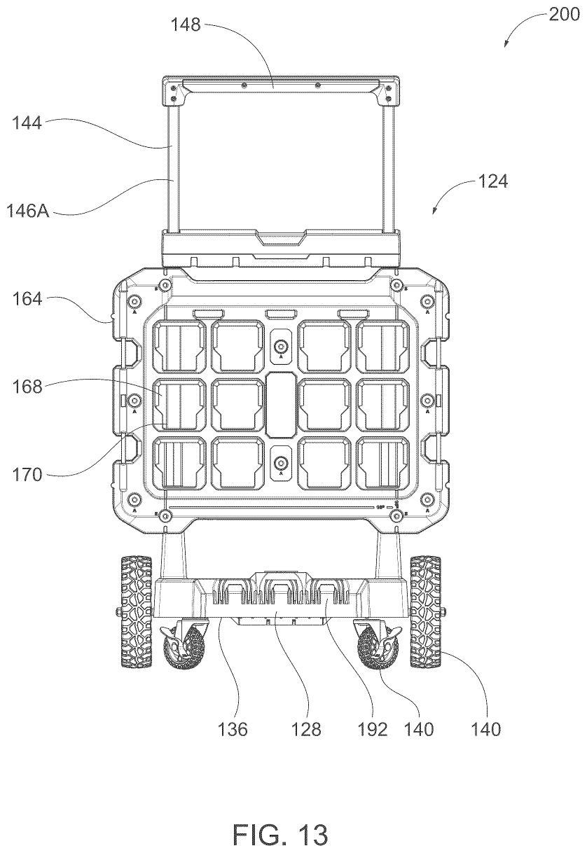

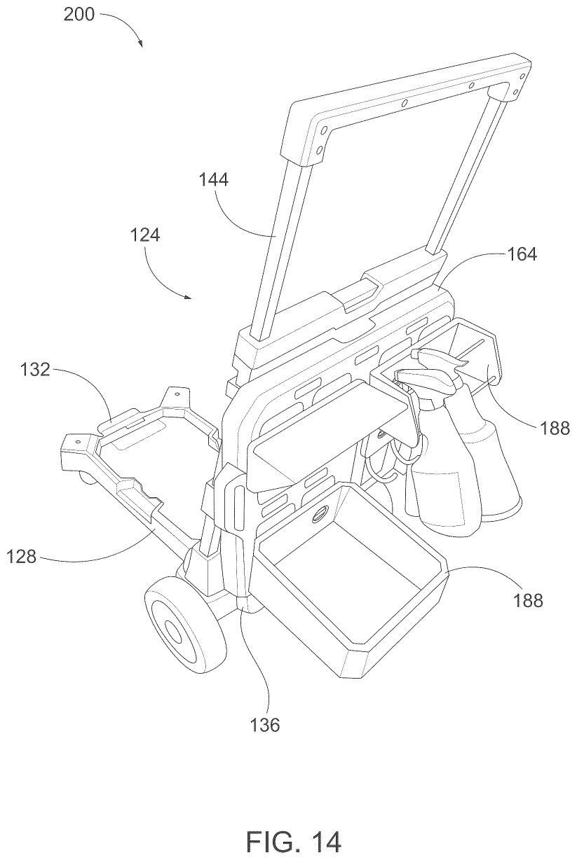

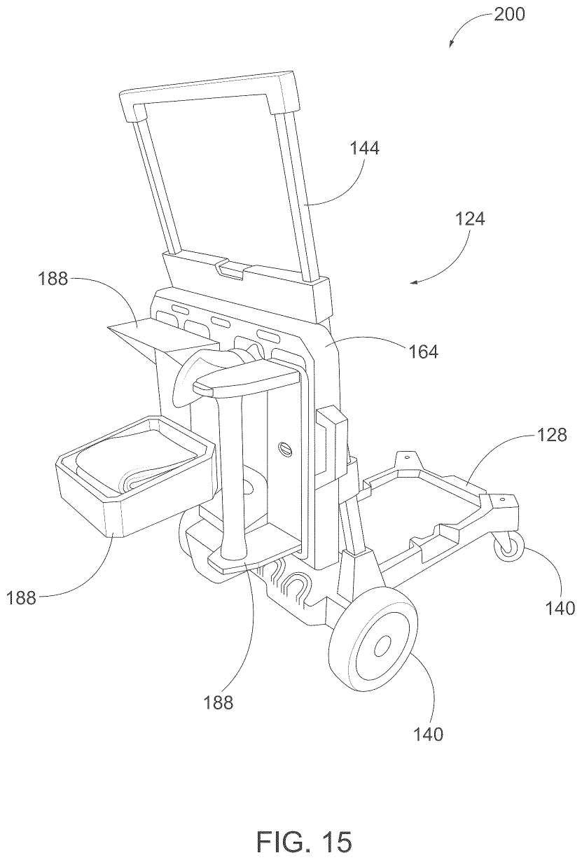

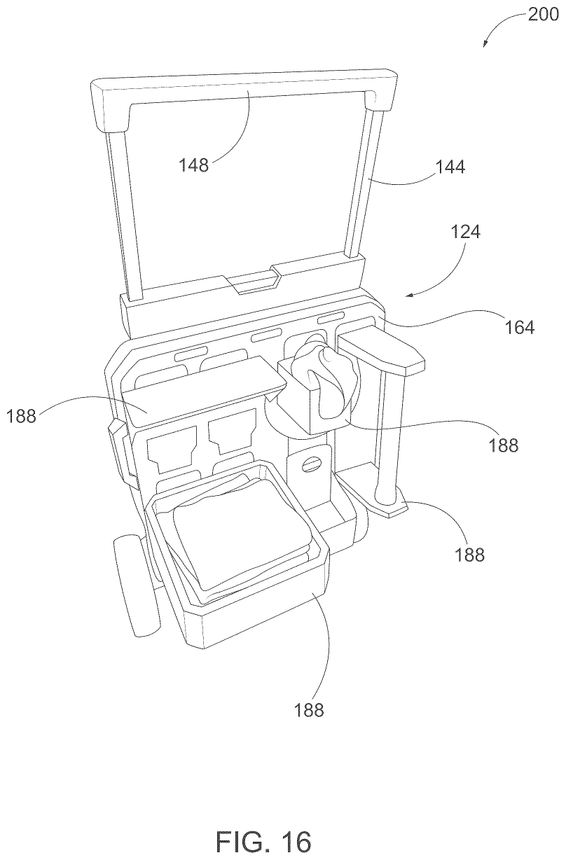

FIGS. 10-16 illustrate a further embodiment of a jobsite storage system 200, similar to the jobsite storage system 100 shown and described with respect to FIGS. 1-7, except as otherwise described. The jobsite storage system 200 omits a vacuum device (such as vacuum device 104). In some embodiments, the jobsite storage system 200 can include a vacuum device mounted to its base 128. In other embodiments, the base 128 may support an alternative structure, such as tools, garbage cans, or other jobsite materials (e.g., screws, nails, lights, electrical wire, etc.) that correspond to the profession of the user.

In addition to the omission of a vacuum device (in some embodiments), the jobsite storage system 200 omits the second portion 146B of the handle. Further still, in omitting the vacuum device 104, the jobsite storage system 200 omits a second panel 176 mounted atop a vacuum device 104. However, in some embodiments, the second panel 176 may be mounted directly atop the base 128 of the cart (i.e., where the vacuum device 104 of FIGS. 1-7 is located).

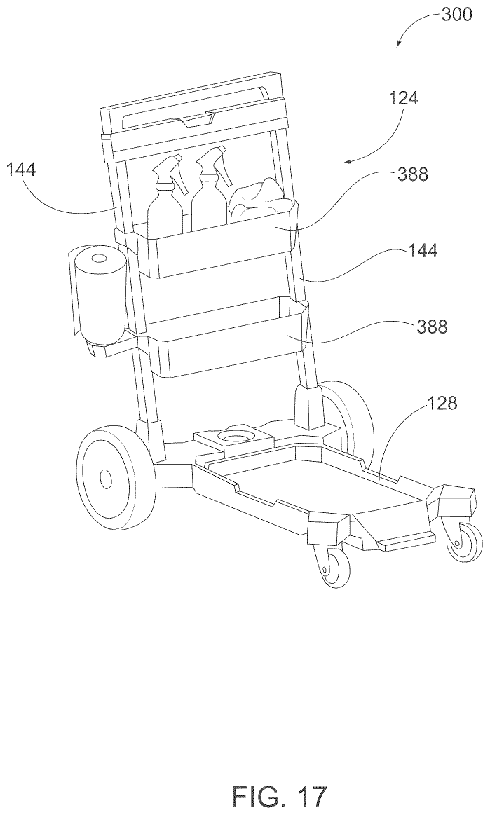

FIG. 17 illustrates a still further embodiment of a jobsite storage system 300 in which the first panel 164 is replaced by two buckets 388 extending in the widthwise direction between the two substantially vertical bars of the handle 144.

Various features of the invention are set forth in the following claims.

What is claimed is:

1. A jobsite storage system comprising:
a vacuum device having a suction source configured to generate a suction airflow and a tank configured to receive debris via the suction airflow; and
a storage cart having:
a base configured to support the vacuum device thereon, the base movable on a ground surface via a plurality of wheels;
a handle extending upward from the base to a grip such that the storage cart is movable via an input of an operator to the grip;
a first securing interface located on the base and configured to removably engage the vacuum device to secure the vacuum device to the base;
a second securing interface located on the handle and configured to removably engage an accessory; and
a third securing interface located on the vacuum device and configured to removably engage the accessory.

2. The jobsite storage system of claim 1, wherein the handle is coupled to the base at a location intermediate between a front end of the base and a rear end of the base such that the second securing interface is configured to engage the accessory at a location above the base.

3. The jobsite storage system of claim 1, wherein the third securing interface is located above the vacuum device and is coupled to an upper side of the vacuum device.

4. The jobsite storage system of claim 1, wherein the second securing interface is one of a plurality of second securing interfaces arrayed on a first panel, and wherein the third securing interface is one of a plurality of third securing interfaces arrayed on a second panel.

5. The jobsite storage system of claim 4, wherein the handle is a first handle and is arranged above a rear end of the base, and wherein the second panel includes a second handle arranged above a front end of the base, opposite the rear end.

6. The jobsite storage system of claim 1, wherein the second securing interface is identical to the third securing interface.

7. The jobsite storage system of claim 1, wherein the second securing interface is one second securing interface of a plurality of second securing interfaces arranged in a rectangular array formed of a plurality of rows and a plurality of columns.

8. The jobsite storage system of claim 1, wherein a side of the base includes a vacuum accessory mount distinct from the first, second, and third securing interfaces.

9. The jobsite storage system of claim 1, wherein the second securing interface is arranged orthogonal to the third securing interface.

10. A jobsite storage system comprising:
a base having a plurality of wheels such that the base is movable on a ground surface, the base extending substantially parallel to the ground surface;
a handle extending from the base, transverse to the base, and terminating at a grip such that the jobsite storage system is movable via an input of an operator to the grip;
a panel coupled to and extending along the handle from a lower end adjacent the base to an upper end located between the lower end of the panel and the grip, the panel including an array of spaced apart securing interfaces, and
a jobsite accessory secured to any securing interface of the array of spaced apart securing interfaces.

11. The jobsite storage system of claim 10, wherein the jobsite accessory is a basket, a bucket, a hook, a paper towel dispenser, or a broom holder.

12. The jobsite storage system of claim 10, wherein the array of spaced apart securing interfaces is a rectangular array formed of a plurality of rows and a plurality of columns of securing interfaces, wherein each securing interface of the rectangular array is identical.

13. The jobsite storage system of claim 10, wherein each securing interface of the array of spaced apart securing interfaces includes a recess configured to receive a portion of the jobsite accessory.

14. The jobsite storage system of claim 13, wherein the jobsite accessory includes a locking element configured to transition between a locked position in which the jobsite accessory is secured within the recess and an unlocked position in which the jobsite accessory is removable from the recess.

15. The jobsite storage system of claim 14, wherein the recess includes a keyhole opening having an upper portion with a greater width than a lower portion.

16. The jobsite storage system of claim 10, wherein the handle extends upward and rearward from the base to the grip, and wherein the panel is coupled to the handle via a lower bracket having a first length and an upper bracket having a second length less than the first length such that the panel extends vertically upward.

17. A jobsite storage system comprising:
a vacuum device having a suction source configured to generate a suction airflow and a tank configured to receive debris via the suction airflow;
a storage cart having:
a base configured to support the vacuum device thereon, the base movable on a ground surface via a plurality of wheels;
a handle extending upward from the base to a grip such that the storage cart is movable via an input of an operator to the grip;
a first securing interface located on the base and configured to engage the vacuum device to secure the vacuum device to the base; and
a first panel mounted substantially vertically to the handle, the first panel having a plurality of second securing interfaces configured to engage an accessory; and
a second panel mounted substantially horizontally above the vacuum device such that the vacuum device is located between the base and the second panel, the second panel having a plurality of third securing interfaces configured to engage the accessory.

18. The jobsite storage system of claim 17, wherein the second panel is coupled to an upper surface of the vacuum device.

19. The jobsite storage system of claim 17, wherein the plurality of second securing interfaces are arranged in a rectangular array on the first panel and the plurality of third securing interfaces are arranged in a rectangular array on the second panel.

20. The jobsite storage system of claim 17, wherein the first panel extends transverse to the handle such that a lower one of the second security interfaces is spaced apart from the handle by a first distance and an upper one of the second security interfaces is spaced apart from the handle by a second distance less than the first distance.
